(19) United States
(12) Patent Application Publication
(10) Pub. No.: US 2026/0075051 A1
(43) Pub. Date: Mar. 12, 2026

(54) Detecting Credentials Abuse of Cloud Compute Services

(71) Applicant: Palo Alto Networks, Inc., Santa Clara, CA (US)

(72) Inventors: Dror Alon, Beer Yaakov (IL); Niv Sela, Tel Aviv-Yafo (IL); Or Kliger, Tel Aviv (IL); Guy Arazi, Rosh Haayin (IL)

(21) Appl. No.: 19/390,756

(22) Filed: Nov. 17, 2025

Related U.S. Application Data
(63) Continuation of application No. 17/844,097, filed on Jun. 20, 2022, now Pat. No. 12,506,729.

(51) Int. Cl. H04L 9/40

(52) U.S. Cl. CPC H04L 63/083; H04L 63/1425

(57) ABSTRACT

Methods, storage systems and computer program products implement embodiments of the present invention that include detecting an access by a networked entity to a service associated with a first autonomous system number (ASN) using a credential assigned to entities associated with the first ASN, determining whether the networked entity is authorized to use the credential by identifying a second ASN associated with the networked entity and with the credential, comparing the first ASN to the second ASN, and performing a security action upon determining that the networked entity is not authorized to use the credential based on a mismatch between the first ASN and the second ASN.

### CROSS-REFERENCE TO RELATED APPLICATIONS

This application is a continuation of U.S. patent application Ser. No. 17/844,097, filed on Jun. 20, 2022, which is hereby incorporated by reference in its entirety.

### FIELD OF THE INVENTION

The present invention relates generally to computer security and networks, and particularly to preventing cyberattacks on network services by detecting unauthorized use of access tokens.

### BACKGROUND OF THE INVENTION

Authentication and authorization are two critical concepts in access control. Authentication is essentially verifying the identity of an entity (e.g., a user or a computing resource such as a physical computers, virtual machines, and cloud-based resources and services). Authentication enables access control by proving that an entity's credentials match those in a database, thereby ensuring system security, process security, and corporate information security.

Authorization typically occurs after a system has successfully authenticated the identity of an entity. An authorization system will then allow access to resources such as information, files, databases, or specific operations and capabilities. After a system authenticates a user, the authorization system verifies access to the required resources. Authorization is the process of determining whether an authenticated user can access a particular resource or perform a specific action. For example, after a file server authorizes a user, the file server can determine which files or directories that can be read, written, or deleted.

Some systems implement token-based authorization via the use of access tokens. Access tokens are used in token-based authentication to allow an application to access a service (e.g., a storage service). An entity receives an access token after a being successfully authenticated. Upon receiving the access token, the entity can convey the access token as a credential when it conveys a request (e.g., an API call) to the service. The conveyed token informs the service that the bearer of the token has been authorized to access the service and perform specific actions specified by the scope that was granted during authorization.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method, including identifying determining a first autonomous system number (ASN) for a service hosted by a networked entity, retrieving, from a log file, an entry corresponding to an access by a networked entity to the service and including an Internet Protocol (IP) address of the networked entity and an access token authorizing access to the service, detecting, by a processor, an access token conveyed from an Internet Protocol (IP) address to the service, identifying determining a second ASN for the IP address, comparing, by a processor, the second ASN to the first ASN, and generating an alert for the access upon detecting the first ASN differing from the second ASN.

In one embodiment the method further includes determining a first organization for the first ASN, and determining a second organization for the second ASN.

In some embodiments, the generated alert includes a first alert upon determining that the first organization matches the second organization, the generated alert includes a second alert upon determining that the first organization does not match the second organization, and the second alert indicates a greater threat than the first alert.

In another embodiment, the service hosted by the networked entity includes a first service hosted by a first networked entity and the method includes assigning, by a second service hosted by a second networked entity, the access token to a resource having the IP address belonging to the first ASN.

In a first resource embodiment, the resource includes a physical computing device.

In a second resource embodiment, the resource includes virtual machine.

In a third resource embodiment, the resource includes a cloud service.

In a first networked entity embodiment, the networked entity includes a virtual machine.

In a second networked entity embodiment, the networked entity includes a physical computing device.

In a third networked entity embodiment, the networked entity includes a cloud service.

There is also provided, in accordance with an embodiment of the present invention, an apparatus, including a network interface controller (NIC), and one or more processors configured to identify a first autonomous system number (ASN) for a service hosted by a networked entity, to retrieve, from a log file via the NIC, an entry corresponding to an access by a networked entity to the service and including an Internet Protocol (IP) address of the networked entity and an access token authorizing access to the service, to identify a second ASN for the IP address, to compare the second ASN to the first ASN, and to generate an alert for the access upon detecting the first ASN differing from the second ASN.

There is additionally provided, in accordance with an embodiment of the present invention, a computer software product, the product including a non-transitory computer-readable medium, in which program instructions are stored, which instructions, when read by a computer, cause the computer to identify a first autonomous system number (ASN) for a service hosted by a networked entity, to retrieve, from a log file, an entry corresponding to an access by a networked entity to the service and including an Internet Protocol (IP) address of the networked entity and an access token authorizing access to the service, to identify a second ASN for the IP address, to compare the second ASN to the first ASN, and to generate an alert for the access upon detecting the first ASN differing from the second ASN.

### BRIEF DESCRIPTION OF THE DRAWINGS

The disclosure is herein described, by way of example only, with reference to the accompanying drawings, wherein:

FIG. 1 is a block diagram that shows an example of a security server that can detect abused authorization credentials used to launch a cyberattack on a service hosted in a computing facility, in accordance with a first embodiment of the present invention;

FIG. 2 is a block diagram showing an example of a raw event log storing information on accesses to the service, in accordance with an embodiment of the present invention;

FIG. 3 is a block diagram showing an example configuration of the security server, in accordance with an embodiment of the present invention;

FIGS. 4A and 4B, referred to collectively herein as FIG. 4, are block diagrams schematically illustrating the cyberattack, in accordance with the first embodiment of the present invention;

FIGS. 5A and 5B, referred to collectively herein as FIG. 2, are block diagrams schematically illustrating a cyberattack on the service hosted by a cloud provider, in accordance with a second embodiment of the present invention; and

FIG. 6 is a flow diagram that schematically illustrates a method of detecting use of stolen credentials, in accordance with an embodiment of the present invention.

### DETAILED DESCRIPTION OF EMBODIMENTS

Embodiments of the present invention provide methods and systems for recommending detecting use of stolen credentials. In embodiments described herein, the credentials may comprise an access token, and the abuse comprises may comprise unauthorized use of the access token 24 for exfiltrating sensitive data. As described hereinbelow, an autonomous system number (ASN) is identified for a service (e.g., a storage service) hosted by a networked entity, and an access to the service can be detected by retrieving, from a log file, an entry corresponding to the access by a networked entity to the service and comprising an Internet Protocol (IP) address of the networked entity and an access token authorizing access to the service. A second ASN is identified for the IP address, and upon comparing the second ASN to the first ASN, an alert is generated for the access upon detecting the first ASN differing from the second ASN.

In embodiments described hereinbelow, an organization may use managed cloud service to provide resources that can use access tokens to access data stored on a storage service also managed by the cloud service. Since the IP addresses of the resources and the services typically belong to the same ASN, security systems implementing embodiments of the present invention can be used to detect a cyberattack in which a computer, having an IP address belonging to a different ASN, attempts to use an access token (i.e., that was assigned to a given resource) to gain access to the data in the storage service.

### SYSTEM DESCRIPTION

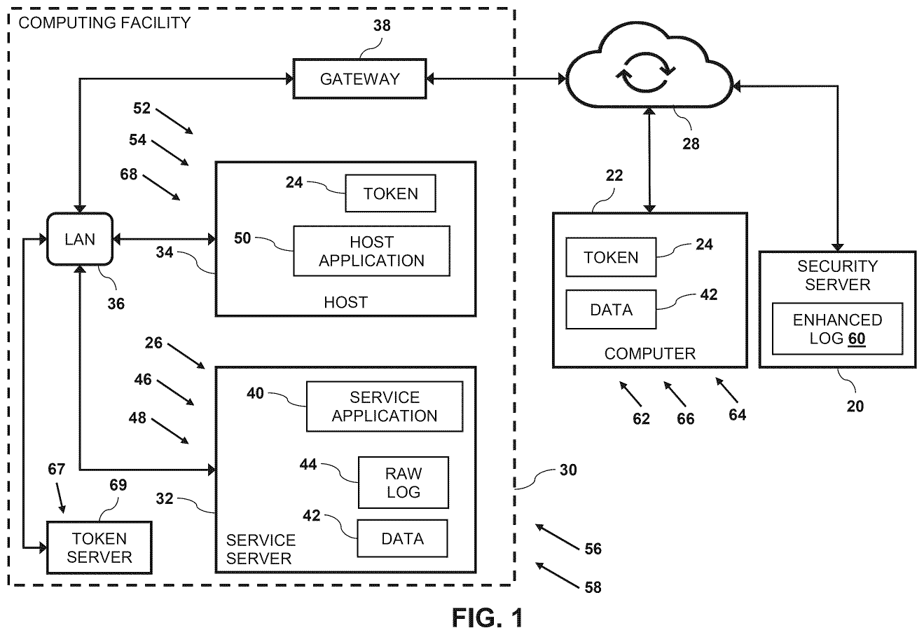

FIG. 1 is a block diagram that schematically shows an example of a security server 20 that can detect a networked entity (e.g., computer 22) using a stolen access token 24 to access a service 26 via a public network 28 such as the Internet, in accordance with a first embodiment of the present invention.

In the configuration shown in FIG. 1, a computing facility 30 comprises a service server 32 and a host computer 34 that can communicate over a local area network (LAN) 36, and a gateway 38 that couples local area network 36 to Internet 28. Computer 22 is external to computing facility 30, and may be referred to herein as external computer 22.

Service server 32 can execute a service application 40 so as to provide service 26. For example, service application 40 may comprise a storage service that manages data 42 stored in data facility 30.

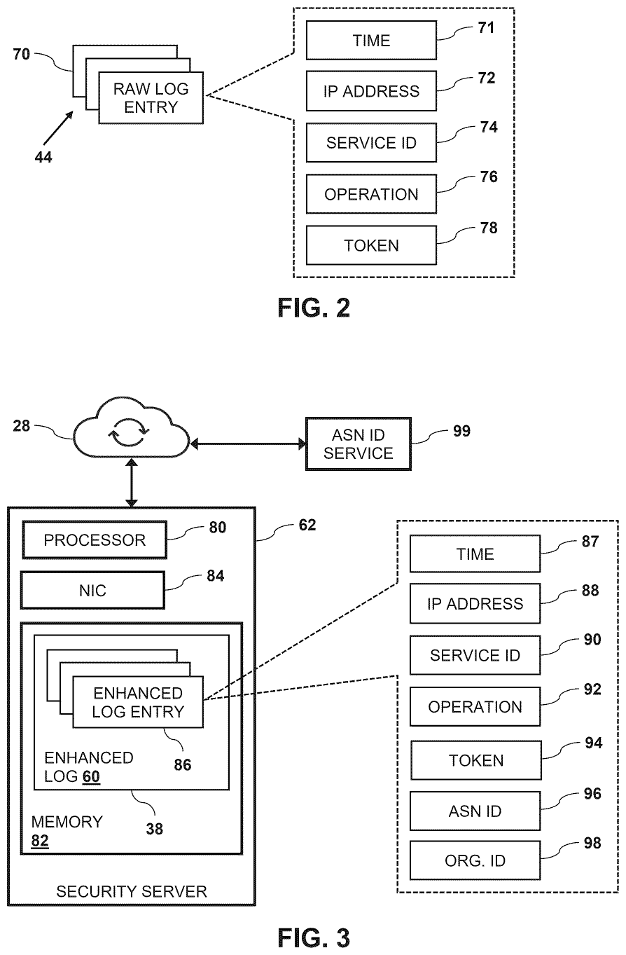

In some embodiments, server 32 comprises a raw event log 44 that stores details of accesses to service 26. Raw event log 44 is described in the description referencing FIG. 2 hereinbelow.

Server 32 also has a server IP address 46, and service 26 has a service identifier (ID) 48. While the configuration of computing facility 30 in FIG. 1 shows a single server 32 providing a single service 26, there may be instances when the computing facility comprises multiple servers 32 (comprising respective IP addresses 46) providing respective services 26 having corresponding unique service IDs 48. For example, computing facility 30 may comprise multiple servers 32 providing respective storage services 26, and the storage services can have corresponding service IDs 48 such as Storage1, Storage2 . . . StorageN.

Host computer 34 stores access token 24, and executes a host application 50 that is configured to access service 26 by conveying the access token to server application 40. Host computer 34 has a host IP address 52 and provides (i.e., to computing facility 30) a resource 68 referenced by a resource ID 54.

While the configuration of computing facility 30 in FIG. 1 shows a host computer 34 accessing a single service 26, there may be instances when the computing facility comprises multiple host computers 34 accessing one or more services 24. In these instances, host computers 34 (comprising respective IP addresses 62) provide respective resources 68 having corresponding unique resource IDs 54.

Computing facility 30 has a facility organization ID 56, and a facility autonomous system number (ASN) 58. The organization ID can reference an organization (e.g., a corporation) that stores corporate data 42 in computing facility 30. ASN 58 typically references a company that has ownership of a specific IP address range that include IP addresses 46 and 52.

In embodiments herein, security server 20 also comprises an enhanced event log 60 that is described in the description referencing FIG. 3 hereinbelow.

In some embodiments, as described hereinbelow, a cyberattack may comprise external computer accessing host application 50 and exfiltrating access token 24, and then using the exfiltrated access token to access server application 40 so as to exfiltrate data 42. The configuration in FIG. 1 shows external computer comprising (i.e., storing) exfiltrated token 24 and exfiltrated data 42.

External computer 20 has an external IP address 62, an external organization ID 64 and an external ASN 66. In one embodiment, as described hereinbelow, organization ID 64 may match organization ID 56. In another embodiment, organization IDs 56 and 64 may differ.

Computing facility 30 may also comprise a token service 67 provided (i.e., hosted) by a token server 69. In some embodiments, token service 67 can provide access token 24 to an authorized networked entity such as host computer 34.

FIG. 2 is a block diagram showing an example of raw event log 44, in accordance with an embodiment of the present invention. In the configuration shown in FIG. 2, raw event log 44 comprises a set of raw event log entries 70. In some embodiments, each log entry 70 corresponds to a given access to a given service 26 (as described supra, computing facility 30 may host multiple services 26), and stores, for each given access, information such as:
A time 71 indicating a date and a time of the given access.
An IP address 72 comprising the IP address (e.g., IP address 52 or IP address 62) of a given networked entity (e.g., computer 22) that accessed service 26.
A service ID 74 referencing a given service 26 that was used in the given access.
An operation 76 performed in the given access. For example, if service ID 74 represents a given storage service 26, then operation 76 can summarize what (e.g., a data read or a data write) was requested in the given access.
A token 78 comprising (or referencing) a given token 24 used in the given access.

For purposes of simplicity, the configuration in FIG. 1 shows server 32 storing raw event log 44. In embodiments where computing facility comprises multiple service servers 32 hosting multiple services 26, computing facility may comprise a log server (not shown) that stores log 44, and log entries 70 store information for all accesses to all services 26.

FIG. 3 is a block diagram showing an example configuration security server 20, in accordance with an embodiment of the present invention. In the configuration shown in FIG. 3, security server 20 comprises a security processor 80, a security memory 82 storing enhanced event log 60, and a network interface card (NIC) 84 that couples the security server to Internet 28, thereby enabling communication with server 32.

In some embodiments, log 60 may comprise a set of enhanced log entries 86 having a one-to-one correspondence with log entries 70. Each log entry 86 can stores information such as:
A time 87. Processor 80 can store time 71 from the corresponding log entry 70 to time 87.
An IP address 88. Processor 80 can store IP address 72 from the corresponding log entry 70 to IP address 88.
A service ID 90. Processor 80 can store service ID 74 from the corresponding log entry 70 to service ID 90.
An operation 92. Processor 80 can store operation 76 from the corresponding log entry 70 to operation 92.
A token 94. Processor 80 can store token 78 from the corresponding log entry 70 to token 94.
ASN ID 96. In some embodiments, processor 80 can convey, to an ASN ID service 99 via Internet 28, a request comprising IP address 88, and receive a response (i.e., from the ASN ID service in response to the request) comprising ASN ID 96. One example of ASN ID service 99 is GEOIP™ (provided by MAXMIND INC., 410 Terry Avenue North Seattle, WA 98109 USA).
An organization ID 98. There are instances when organizations have multiple ASN IDs 96. Processor 80 can convey, to ASN ID service 99 via Internet 28, a request comprising IP address 88, and receive a response (i.e., from the ASN ID service in response to the request) comprising organization ID 98.

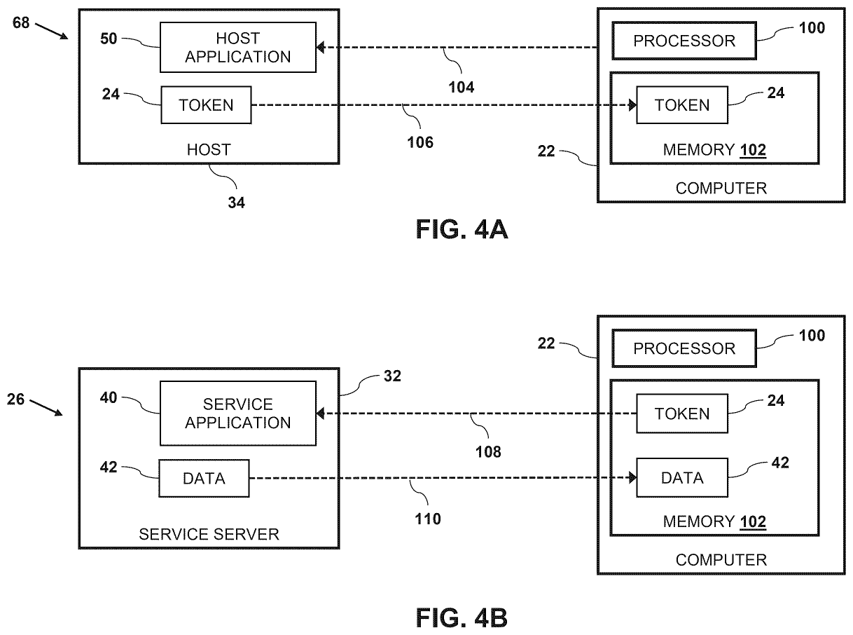

FIGS. 4A and 4B, referred to collectively herein as FIG. 4, are block diagrams schematically illustrating an example of a server-side request forgery (SSRF) cyberattack that can be detected by security server 20, in accordance with the first embodiment of the present invention. In the configuration shown in FIG. 4, external computer 22 comprises an external processor 100 and an external memory 102.

As shown in FIG. 4A, processor 100 launches the cyberattack by conveying, to resource 68 (provided by host application 50) a transmission 104 (typically comprising data packets such as TCP/IP packets) that includes malicious instructions (not shown). In response to receiving and executing the received malicious instructions, host 34 conveys, to computer 22, a transmission 106 comprising token 24, which processor 100 stores to memory 102.

As shown in FIG. 4B, processor 100 continues the cyberattack by conveying, to service 26 (provided by service application 40), a transmission 108 comprising token 24. Upon receiving (and validating) token 24, service 26 grants computer 22 access to data 42. Upon being granted access, processor 100 can exfiltrate data 42 via one or more transmissions 110 (i.e., from server 32 to computer 22), and store the exfiltrated data to memory 102.

Processors 80 and 100 comprise general-purpose central processing units (CPU) or special-purpose embedded processors, which are programmed in software or firmware to carry out the functions described herein. This software may be downloaded to code server security server 20 or external computer 22 in electronic form, over a network, for example. Additionally or alternatively, the software may be stored on tangible, non-transitory computer-readable media, such as optical, magnetic, or electronic memory media. Further additionally or alternatively, at least some of the functions of processors 80 and 100 may be carried out by hard-wired or programmable digital logic circuits.

Examples of memories 82 and 102 include dynamic random-access memories, non-volatile random-access memories, hard disk drives and solid-state disk drives.

In some embodiments, tasks described herein performed by host(s) 34, server(s) 32, security server 22 and token server 69 may be split among multiple physical and/or virtual computing devices such as physical server and/or virtual server. In other embodiments, these tasks may be performed by a managed cloud service such as AMAZON WEB SERVICES™ (also known as AWS™, provided by AMAZON.COM, INC., 51 Pleasant Street #1020. Malden, MA 02148. USA).

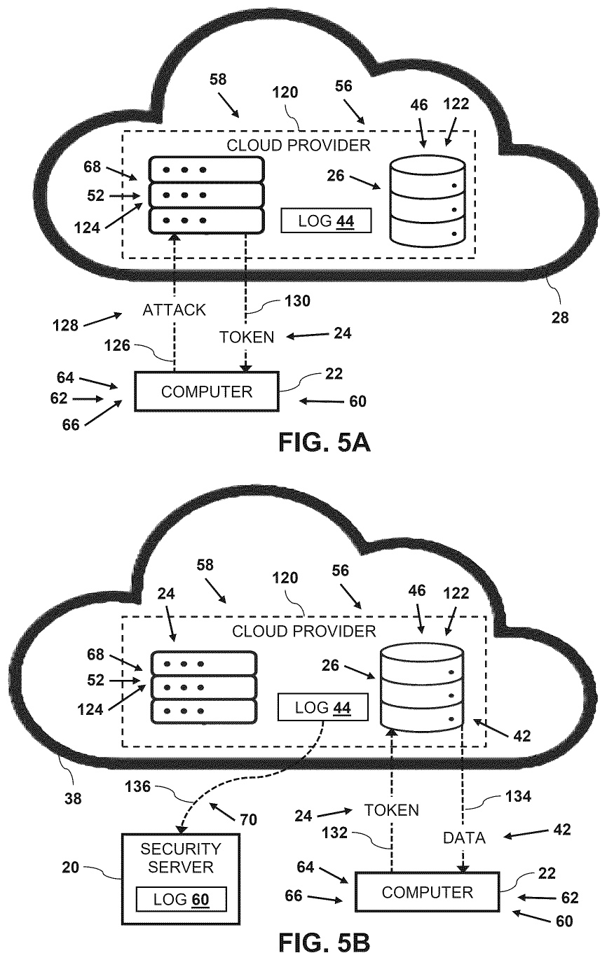

FIGS. 5A and 5B, referred to collectively herein as FIG. 2, are block diagrams schematically illustrating an SSRF cyberattack on service 26 hosted by a managed cloud service 120, in accordance with a second embodiment of the present invention. In the second embodiment, service 26 and resource 68 are respectively implemented in virtual machines (VMs) 122 and 124 that are managed by cloud service 120.

As shown in FIG. 5A, computer 22 launches the cyberattack by conveying, to resource 68 hosted on VM 124, a transmission 126 comprising an attack 128 that includes malicious instructions (not shown). In response to receiving and executing the instructions, VM 124 conveys, to computer 22, a transmission 130 comprising token 24.

As shown in FIG. 4B, computer 22 continues the cyberattack by conveying, to service 26 hosted on VM 122, a transmission 132 comprising token 24. Upon receiving (and validating) token 24, service 26 grants computer 22 access to data 42. Upon being granted access, computer 22 can exfiltrate data 42 via one or more transmissions 134 (i.e., from VM 122 to computer 22).

In embodiments described herein, security server 20 can detect the cyberattack by retrieving, in transmissions 136, new log entries 70 stored to event log 44, store the information in the received raw event log entries to event log 60, and analyze the received information.

In embodiments herein, external computer 22, host computer(s) 34, server(s) 32, server 69, and VMs 122, 124 may be referred to as networked entities. For example, service 26 may be hosted by networked entity 32 or networked entity 122.

### STOLEN ACCESS TOKEN DETECTION

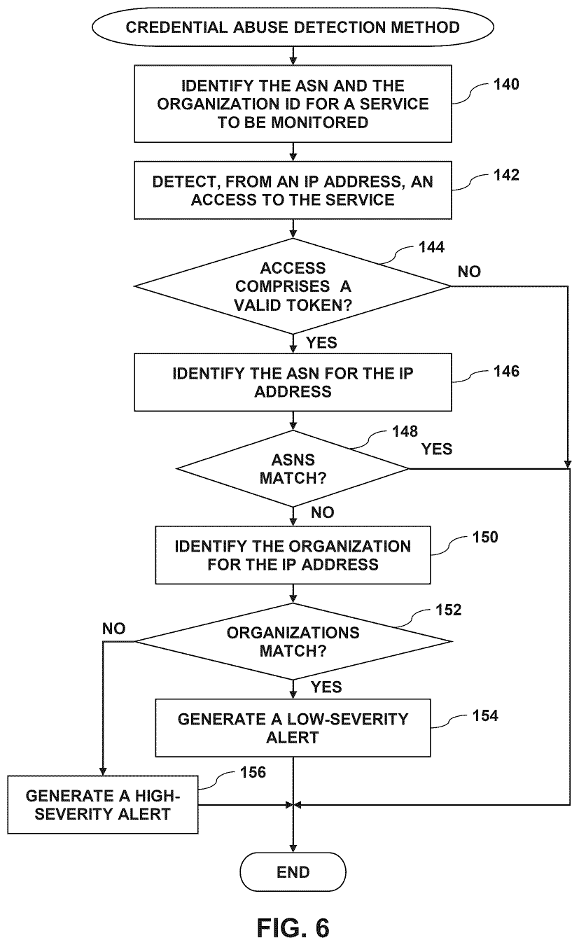

FIG. 6 is a flow diagram that schematically illustrates a method of detecting use of stolen credentials, in accordance with an embodiment of the present invention. In embodiments described herein, the credentials comprise token 24, and the abuse comprises unauthorized use of token 24 so as to exfiltrate data 42.

In step 140, using embodiments described supra, processor 80 identifies ASN 58 and organization ID 56 for (i.e., associated with) a given service 26 (i.e., in computing facility 30 or cloud service 120) to be monitored.

In step 142, processor 80 detects a (new) access, from IP address 62, to service 26 using a given access token 24. In some embodiments the access may comprise service 26 receiving, from a given networked entity (e.g., computer 22 or resource 34), an authorization request comprising access token 24. Upon receiving the authorization request, service 26 can add a new raw log entry 70 to event log 44, populate the new raw log entry (i.e., including, but not limited to, IP address 72 and token 78) using embodiments described hereinabove, and convey the new raw log entry to security server 20. Prior to detecting the authorization request, a token management service (not shown) executing on token server 69 can assign, to the given networked entity, access token 24.

In some embodiments, processor 80 can detect the new access by receiving (i.e., retrieving from raw log 44 via NIC 84), from service 26, a the new raw log entry (i.e., corresponding to the new access). Upon the new raw event log entry, create a new corresponding log entry 86 in enhanced log 60, and populate the new enhanced log entry with information using embodiments described hereinabove.

In step 144, processor 80 analyzes the given access token so as to determine whether or not the given access token is valid. For example, the given token may have an expiration date and time, and processor can check whether or not time 87 is prior to the expiration.

If processor 80 determines that the given access token is valid, then in step 146, the security processor uses embodiments described hereinabove to identify ASN 66 for IP address 62.

In step 148, processor 80 compares ASN 58 to ASN 66. If, based on the comparison, processor 80 detects that ASN 58 does not match ASN 66, then in step 150, the security processor uses embodiments described hereinabove to identify organization ID 64 for (i.e., associated with) IP address 66.

In step 152, processor 80 compares organization ID 56 to organization ID 64. If processor 80 detects, based on the comparison, that organization ID 56 matches organization ID 64, then in step 154 the security processor generates a low-severity alert (i.e., for the new access corresponding to the received new raw log entry), and the method ends. The following are examples of why a low-level alert may be warranted if organization ID 56 matches organization ID 64:
Computer 22 and service 26 (i.e., in the first embodiment described in the description referencing FIG. 4 hereinabove) may belong to the same organization. Even though token 24 was allocated to host computer 34, computer 22 using token 24 may be ill-advised (i.e., from a cybersecurity perspective), but is probably not malicious.
Virtual machines 122 and 124 (i.e., in the second embodiment described in the description referencing FIG. 5 hereinabove) may by provisioned by a single cloud service 120 but have different ASNs. For example, VM 122 may be provisioned by the cloud provider in a first geolocation, having a first IP address 46 belonging to a first ASN 58, and VM 124 may be provisioned by the cloud provider in a second geolocation, having a second IP address 46 belonging to a second ASN 58.

Returning to step 152, if, based on the comparison, processor 80 does not a match between organization ID 56 and organization ID 64, then in step 156, the security processor 80 generates a high-severity alert, and the method ends. In embodiments herein, a high severity alert indicates more suspicious activity (e.g., the given access poses a greater threat) than a low-severity alert (i.e., the alert generated in step 154).

Returning to step 148, if processor 80 detects, based on the comparison, that ASN 58 matches ASN 66, then the method ends (i.e., processor 80 classifies the given access as legitimate).

Returning to step 144, If processor 80 determines that the given access token is not valid, then the method ends. In this case service 26 will not grant access to data 42 upon receiving an invalid token 24.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
detecting, by a processor, an access by a networked entity to a service associated with a first autonomous system number (ASN) using a credential assigned to entities associated with the first ASN;
determining whether the networked entity is authorized to use the credential by identifying a second ASN associated with the networked entity and with the credential, and comparing the first ASN to the second ASN; and
performing a security action upon determining that the networked entity is not authorized to use the credential based on a mismatch between the first ASN and the second ASN.

2. The method of claim 1, wherein the credential comprises an access token, an API key, a certificate, or a session token.

3. The method of claim 1, wherein the security action comprises generating an alert, blocking access to the service, revoking the credential, or throttling access requests from the networked entity.

4. The method of claim 1, wherein the networked entity comprises a physical computing device, a virtual machine, or a cloud service.

5. The method of claim 1, further comprising generating alerts of different severity levels depending on whether an organization associated with the first ASN matches an organization associated with the second ASN.

6. The method of claim 1, further comprising storing enhanced event logs including ASN identifiers and organization identifiers for accesses to the service.

7. The method of claim 1, further comprising detecting exfiltration of data from the service using the credential.

8. The method of claim 1, further comprising detecting a server-side request forgery (SSRF) attack based on use of the credential.

9. An apparatus, comprising:
a network interface controller (NIC); and
one or more processors configured:
to detect an access by a networked entity to a service associated with a first autonomous system number (ASN) using a credential assigned to entities associated with the first ASN;
to determine whether the networked entity is authorized to use the credential by identifying a second ASN associated with the networked entity and with the credential, and comparing the first ASN to the second ASN; and
to perform a security action upon determining that the networked entity is not authorized to use the credential based on a mismatch between the first ASN and the second ASN.

10. The apparatus of claim 9, wherein the credential comprises an access token, an API key, a certificate, or a session token.

11. The apparatus of claim 9, wherein the processors are further configured to perform a security action comprising generating an alert, blocking access to the service, revoking the credential, or throttling access requests from the networked entity.

12. The apparatus of claim 9, wherein the networked entity comprises a physical computing device, a virtual machine, or a cloud service.

13. The apparatus of claim 9, wherein the processors are further configured to generate alerts of different severity levels depending on whether an organization associated with the first ASN matches an organization associated with the second ASN.

14. The apparatus of claim 9, wherein the processors are further configured to store enhanced event logs including ASN identifiers and organization identifiers for accesses to the service.

15. The apparatus of claim 9, wherein the processors are further configured to detect exfiltration of data from the service using the credential.

16. The apparatus of claim 9, wherein the processors are further configured to detect a server-side request forgery (SSRF) attack based on use of the credential.

17. A non-transitory computer-readable medium storing instructions which, when executed by a computer, cause the computer to:
detect an access by a networked entity to a service associated with a first autonomous system number (ASN) using a credential assigned to entities associated with the first ASN;
determine whether the networked entity is authorized to use the credential by identifying a second ASN associated with the networked entity and with the credential, and comparing the first ASN to the second ASN; and
perform a security action upon determining that the networked entity is not authorized to use the credential based on a mismatch between the first ASN and the second ASN.

18. The computer-readable medium of claim 17, wherein the credential comprises an access token, an API key, a certificate, or a session token.

19. The computer-readable medium of claim 17, wherein the instructions further cause the computer to perform a security action comprising generating an alert, blocking access to the service, revoking the credential, or throttling access requests from the networked entity.

20. The computer-readable medium of claim 17, wherein the instructions further cause the computer to log the mismatch in an enhanced event log including ASN identifiers and organization identifiers.
